(19) United States
(12) Patent Application Publication
(10) Pub. No.: US 2012/0264848 A1
(43) Pub. Date: Oct. 18, 2012

(54) POLYMER EMULSION FOR PAVEMENT SEALING

(76) Inventor: Jack H. Wilson, SR., Ridgeland, MS (US)

(21) Appl. No.: 13/448,123

(22) Filed: Apr. 16, 2012

Related U.S. Application Data
(63) Continuation of application No. 12/155,875, filed on Jun. 11, 2008.

(51) Int. Cl. C04B 26/04; C08K 3/34

(52) U.S. Cl. 523/135; 524/2

(57) ABSTRACT

A pavement sealing composition and method of application of the sealant to pavement to form a thin coating which protects the pavement, particularly asphalt from the harmful effects of oxidation, water, ice and snow as well as fluids spilled onto the pavement surface from automobiles and aircraft. Preferably, the coating is formed of a polymer based emulsion.

### RELATED APPLICATIONS

This application is a continuation of U.S. patent application Ser. No. 12/155,875 having a filing date of Jun. 11, 2008 and claims priority therefrom and also incorporates that application by reference herein in its entirety.

### FIELD OF THE INVENTION

The present invention relates to pavement coating compositions and methods of application of the composition to bituminous pavement.

### BACKGROUND OF THE INVENTION

Asphalt (bituminous pavement) is the world's most commonly used pavement material. Transportation infrastructure has used asphalt in road building in every country in the world and asphalt is an excellent product for roads, parking lots, drive-thru's, airport taxiways, runways, and tarmacs. It has many advantages but also has one critical weakness, and that being asphalt is a temporary material. Oxidation causes severe deterioration in asphalt surfaces if the surface is left unprotected. In areas that experience ice and snow, unprotected asphalt can and often will be severely damaged by the melting snow and ice. Further damage is caused to unprotected asphalt by substances such as salt employed to accelerate melting of snow and ice. Automotive fluids such as brake fluid, oil, gasoline, diesel fuel etc. leaking from automobiles also have a significant adverse effect on the longevity of unprotected asphalt surfaces. Automotive fluids of the type identified above along with the oxidation process cause unprotected asphalt to ravel and pot holes to form. When asphalt cracks, the wall of the crack is exposed to U.V. and rainwater, which destroys the binder that holds the rocks in the mix in place. This eventually leads to crack wall erosion which allows water to penetrate the base and wet the foundation of the road. When this happens the road loses its structural integrity and potholes appear. Crack filling is an expensive process that has a relatively short lifespan. Furthermore, approximately every 6 years the wearing surface must be milled and replaced with a 1½ inch wearing surface because it is severely affected by water, oxidation, UV, and automotive fluids. For years, the asphalt industry has searched for ways to improve the longevity of asphalt and become more competitive with the concrete industry

This search led to the development of the asphalt sealing industry which has now existed for many years. This industry's primary function is to apply a protective sealant such as a coal tar sealant to new and chip seal to old asphalt surfaces to retard oxidation and further to protect the asphalt surface from the damaging effects of fluids as water and those emitted from an automobile. The sealing industry emerged in large part to overcome the undesirable deterioration of unprotected asphalt. Sealant contractors in this industry have for many years contracted with various individuals and businesses to apply coal tar sealants to asphalt surfaces to prevent deterioration. Coal tar sealants are generally effective but there are a number of disadvantages attendant to their application and use. For example, the application of a coal tar sealant by spray equipment allows particles to become airborne and thereby soiling workers, buildings and numerous other animate and inanimate objects. Coal tar sealants also have a significant tracking problem. This is due in large part to the prolonged curing period attendant spray application of the coal tar sealant. The tracking problem is particularly troublesome for restaurant and/or fast food proprietors because the sealant is tracked into the establishment. Another disadvantage attendant coal tar sealants is the very strong odor.

Another important concern is the breathing of polycyclic aromatic hydrocarbon vapors by workers applying the coal tar sealant. Long-term exposure to these airborne hydrocarbons may have serious health effects on the workers.

In an effort to overcome these disadvantages to coal tar sealants and the decay of asphalt pavement, attempts have been made to use other materials such as concrete to seal asphalt pavement surfaces such as parking lots. However, thin layers of concrete without polymer modification are subject to brittleness which allows an unacceptable amount of chipping and cracking and has an unacceptable time for curing prior to being put back in to service. Even prior formulations of polymer modified concrete are unacceptable in situations which demand simultaneous repair of cracking along with sealing.

Therefore, it can be seen that there is a need for a polymer modified concrete formulation which overcomes the disadvantages of coal tar sealants and chip seals, and provides a quick return to service so that the pavement can be put back into use soon after the application of the sealant and eliminate the need for milling the asphalt surface and applying a new wearing surface. Additional objects and advantages of the invention will become apparent upon reading of the detailed description of the invention in conjunction with the accompanying drawings.

### OBJECTS AND SUMMARY OF THE INVENTION

It is an object of a preferred embodiment of the invention to provide a polymer emulsion which dries quickly so that the pavement can be returned to service soon after application.

Another object of a preferred embodiment of the invention is to provide a polymer emulsion that can be mixed on site and applied to bituminous pavement.

Yet another object of a preferred embodiment of the invention is a polymer emulsion that repairs cracks in pavement.

Yet another object of a preferred embodiment of the invention is to provide a protective layer over asphalt pavement to prevent solar heating of the pavement, and to add illumination without additional energy for street lighting.

Still another object of a preferred embodiment of the invention is to provide a method of applying the pavement sealing composition in a thin layer.

Yet still a further object of a preferred embodiment of the present invention is to provide a pavement sealing composition that provides anti-skid properties to worn bituminous pavement and retards pollution caused by bacteria on the pavement.

These and other objects, uses and advantages will be apparent from a reading of the description which follows with reference to the accompanying drawings forming a part thereof

### BRIEF DESCRIPTION OF THE DRAWINGS

FIG. 1 is a fragmentary perspective view of the method of applying the polymer emulsion over a pavement surface.

FIG. 2 is a fragmentary perspective view of the layer of polymer emulsion in place over the pavement surface.

In summary, the invention is directed to a polymer emulsion and method of application of the emulsion sealant to pavement to fill cracks and form a thin coating which protects the pavement, particularly asphalt from the harmful effects of oxidation, water, ice and snow as well as fluids spilled onto the pavement surface from automobiles and aircraft. Preferably, the coating is formed of a combination of materials including a polymer resin, and Portland cement and water. The composition of the polymer emulsion permits a very thin layer to be applied to pavement surfaces such as asphalt and fills cracks in the asphalt and which when dry forms a hard and durable coating which adheres to the pavement surface and provides a high friction surface.

A polymer emulsion for application to pavement surfaces, comprising a mixture of polymer resin and a defoaming agent blended with a powder mixture of cement and sand and sodium carbonate and water having a solids content between 46.5 and 47.5 percent measured by weight of total liquid, and a viscosity latex between 5 and 55 centipoises, when measured at 77° F. (25° C.).

A polymer emulsion having high solar reflectivity for application to pavement surfaces, comprising a mixture of polymer resin and a defoaming agent blended with a powder mixture of cement and sand and sodium carbonate, titanium dioxide and water having a solids content between 46.5 and 47.5 percent measured by weight of total liquid, and a viscosity latex between 5 and 55 centipoises, when measured at 77° F. (25° C.).

### DETAILED DESCRIPTION OF THE PREFERRED EMBODIMENT OF THE INVENTION

This invention is primarily directed to the sealing of asphalt on roads, airport tarmacs, parking lots and driveways. The sealant composition in the form of a polymer emulsion permits a very thin layer to be applied to pavement surfaces such as asphalt which when dry forms a hard and durable coating which adheres to the pavement surface and provides a high friction surface. The polymer emulsion contains a special blend of quartz aggregate that eliminates the need to pre-fill cracks in asphalt. The aggregate mixture strengthens the formula and is forced down into cracks during the application process using a Super Squeegee Sled. The polymer emulsion coats the wall of the crack and cements the stones in place and eliminates the erosion from water. The aggregate load forms a protective crust that will last for many years. It is an advantage of the invention to seal asphalt pavement with a light colored layer to prevent heating of the asphalt and thereby preventing rutting of the asphalt by vehicle traffic which frequently occurs when the temperature of the asphalt pavement rises on hot, sunny summer days.

The preferred formulation of a first embodiment of the polymer emulsion used as the sealant composition and method of preparation for a batch size of fifty-five gallons will now be described.

In the initial step the following ingredients are combined:

Rohm and Haas Rhoplex E-330

Rohm and Haas Rocima 63

Emerald Foam Control Foam Blast 1063

Start the batch preparation with approximately 53 gals. of Rhoplex E-330. Add about 25 gallons of Rhoplex E-330 to a mixing vat. Mix at low speed in Scholds/Hockmyer style disperser. Add 32 oz of Emerald Foam Control FoamBlast 1063 to batch. Continue to mix at low speed for an additional 30 minutes. Slowly add remaining Rhoplex E-330 to batch. Mix at low speed for an additional 10 minutes. Add 2 lbs. of Rocima 63 to batch. Mix at low speed for an additional 10 minutes.

In the next step, Portland cement and sand are added to the above ingredients. The ratio of sand to cement is 70/30.

The following table describes the preferred sand gradation which meets the ASTM C-387 specification:

| | |
|---|---|
| SPECIFICATION | RESULTS |

| | | |
|---|---|---|
| 4 | 92-100 | 97.1 |
| 8 | 75-100 | 89.8 |
| 16 | 45-90 | 79.9 |
| 30 | 25-70 | 57.6 |
| 50 | 3-35 | 7.3 |
| 100 | 0-10 | 0.9 |

The next series of steps describes adding the Portland cement and sand mixture.

Add 25 gals of water to the mixing vat and continue to mix for 3 minutes. Next add 2,800 lbs. of the Portland cement and sand mixture Powder to the mixing vat and continue to mix for 4 minutes. Next add 200 lbs. of Unimin 2095 Granusil to mixer and continue to mix for 3 minutes. Unimin 2095 Granusil is a quartz sand which provides non-skid properties and enhances the filling of cracks and openings in the pavement surface.

The resulting polymer emulsion should have a solids content shall be between 46.5 and 47.5 percent by weight of total liquid, and viscosity latex between 5 and 55 centipoises, when measured at 77° F. (25° C.).

The water used in mixing the polymer emulsion should be of potable quality and free from harmful-soluble salts. Water content should not exceed 52 percent by weight of total latex liquid.

When mixed and cured in accordance with the above described methods, the materials will demonstrate the properties in the table below.

| Physical Property | Test Method | Minimum Test Value |
|---|---|---|
| Elastic Modulus | ASTM C-469 | 555,000 psi (3827 MPa) |
| Accelerated | ASTM G-23, 4000 hr | Unaffected |
| Weathering | | |
| Shear Bond Adhesion | ASTM C-882 | >550 PSI (3.8 MPa) |
| Slip resistance | ASTM D-2047 | 0.72 (wet) |
| Slip resistance | ASTM D-2047 | 0.74 (dry) |
| Chemical Resistance | ASTM D2299 | Unaffected |
| Splitting Tensile | ASTM C-496 | 570 PSI (3.9 MPa) |
| Strength | | |
| Abrasion Resistance | ASTM C-779-00 | 0.036 inches (0.91 mm) |
| (60 minutes) | | |
| Freeze-Thaw Scaling | ASTM C-672-98 | 0 (No Scaling) |
| Resistance | | |
| Tensile Bond Strength | ASTM D-4541-02 | 200 PSI |

A second embodiment describes the solar reflective sealant composition and method of preparation as follows:

Start the batch preparation with approximately 53 gals. of Rhoplex E-330. Add about 15 gallons of Rhoplex E-330 to a mixing vat. Set the Scholds/Hockmyer style disperser at a high speed setting. Add 32 oz of Supersperse 100. Continue to mix at high speed for 3 minutes. Slowly add 25 lbs. of titanium dioxide to mix and continue to mix at high speed for 45 minutes. Next add 32 oz of FoamBlast 1063 to batch and mix at low speed for 10 minutes. Slowly add 35 gals. of Rhoplex E-330 to batch. Mix at low speed for 10 minutes. Add 2 lbs. of Rocima 63 to batch. Mix at low speed for 10 minutes.

In the next step, Portland cement and sand are added to the above ingredients. The ratio of sand to cement is 70/30.

The following table describes the preferred sand gradation which meets the ASTM C-387 specification:

| | |
|---|---|
| SPECIFICATION | RESULTS |

| | | |
|---|---|---|
| 4 | 92-100 | 97.1 |
| 8 | 75-100 | 89.8 |
| 16 | 45-90 | 79.9 |
| 30 | 25-70 | 57.6 |
| 50 | 3-35 | 7.3 |
| 100 | 0-10 | 0.9 |

The next series of steps describes adding the Portland cement and sand mixture. Next, add 25 gals of water to mixer and continue to mix for 3 minutes. Next, add 2,800 lbs. of the Portland cement and sand mixture to the mixing vat and continue to mix for 4 minutes. Next, add 200 lbs. of Unimin 2095 Granusil to mixer allow to mix for 3 minutes.

The resulting polymer emulsion should have a solids content shall be between 46.5 and 47.5 percent by weight of total liquid, and viscosity latex between 5 and 55 centipoises, when measured at 77° F. (25° C.).

The water used in mixing the polymer emulsion should be of potable quality and free from harmful-soluble salts. Water content should not exceed 52 percent by weight of total latex liquid.

When mixed and cured in accordance with the above described methods, the materials will demonstrate the properties in the table below.

| Physical Property | Test Method | Minimum Test Value |
|---|---|---|
| Elastic Modulus | ASTM C-469 | 555,000 psi (3827 MPa) |
| Accelerated | ASTM G-23, 4000 hr | Unaffected |
| Weathering | | |
| Shear Bond Adhesion | ASTM C-882 | >550 PSI (3.8 MPa) |
| Slip resistance | ASTM D-2047 | 0.72 (wet) |
| Slip resistance | ASTM D-2047 | 0.74 (dry) |
| Chemical Resistance | ASTM D2299 | Unaffected |
| Splitting Tensile | ASTM C-496 | 570 PSI (3.9 MPa) |
| Strength | | |
| Abrasion Resistance | ASTM C-779-00 | 0.036 inches (0.91 mm) |
| (60 minutes) | | |
| Freeze-Thaw Scaling | ASTM C-672-98 | 0 (No Scaling) |
| Resistance | | |
| Tensile Bond Strength | ASTM D-4541-02 | 200 PSI |

Prior to application of the polymer emulsion, the substrate must be properly prepared. The substrate being the pavement surface whether it is a road, parking lot, runway or tarmac. The substrate must be structurally sufficient for it's intended purpose, and in the case of asphalt, cured so there is no concentration of oils on the surface.

The substrate that is to receive the polymer emulsion system shall be cleaned of sand, dirt, dust, rock, or any other debris that could prevent proper adhesion. Cleaning shall be accomplished by power broom, scraping, blowing, washing, or other methods necessary to assure bonding between the polymer emulsion and the substrate.

A degreaser, if needed, will be used to thoroughly remove oils, fuels, or other contaminants that could prevent proper adhesion. Areas identified as soft, unstable, or otherwise unsuitable for overlay during the cleaning process shall be removed to a depth where the substrate is structurally sound and repaired.

When the polymer emulsion is used on a concrete substrate, all curing compound or other surface contaminates that may adversely affect bonding shall be removed.

All cracks greater than ⅛ inch (3 mm) in width shall be cleaned out to remove raveled aggregate, dirt, and organic matter, and pliable joint sealants. The cracks will be blown out with compressed air in a volume sufficient to remove any loose debris. Large cracks will be filled with crack filling material such as Polycon's E-PatchTM or approved equal. Edges of crack-filling material will be left level with and feathered into the adjacent pavement surface.

All substrate receiving the polymer emulsion shall be free of potholes, spalling, or other areas of structural deterioration. All such areas shall be excavated to a depth where the substrate is structurally sound and repaired with Polycon's E-PatchTM or approved equal.

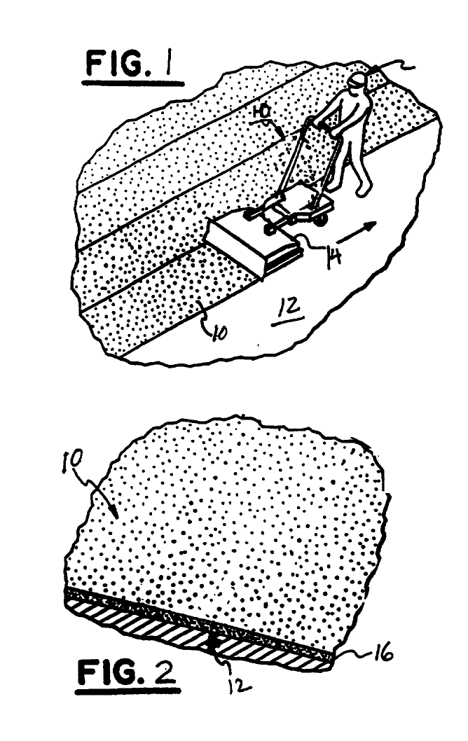

Now referring to FIGS. 1 and 2, the polymer emulsion 10 is applied to the pavement surface 12 by pouring onto the pavement surface 12 and quickly spreading the polymer emulsion 10 using a squeegee 14 to form a layer 16 of approximately 1/64 of an inch to 1/32 of an inch in thickness. It is important that the layer 16 be thin to achieve quick drying and avoid wasting of material. The polymer emulsion will dry in 10 to 30 minutes in 70 degrees Fahrenheit and above air and ground temperatures at this thickness and will harden to provide a durable seal over the pavement surface 12 and permit the pavement surface to be put back into service. In spreading the emulsion, it is important that the squeegee 14 or trowel (not shown) not pass over the sealant composition 10 more than two times as this tends to bring the liquid to the surface thus separating the polymer resin from the sand and cement.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims.

1-2. (canceled)

3. A polymer modified cement protective coating for application to pavement surfaces comprising:
a) a polymer emulsion having a polymer solids content of between 46.5 and 47.5 percent by weight;
b) said polymer emulsion including a blend of Portland cement, sand, quartz aggregate having non-skid properties and water.

4. A polymer emulsion for application to pavement surfaces, comprising:
a mixture of polymer resin blended with a powder mixture of cement and sand and sodium carbonate and water wherein said polymer emulsion includes a quartz sand having non-skid properties so that when said polymer emulsion is mixed and cured and applied to a pavement surface at a thickness in the range of approximately 1/64 to 1/32 of an inch said polymer emulsion will have a minimum test value of slip resistance of 0.72 when wet according to test method ASTM D-2047.

5. A polymer emulsion for application to pavement surfaces as set forth in claim 4, wherein:
a) when cured, said polymer emulsion will have a minimum test value of slip resistance of 0.74 when dry according to test method ASTM D-2047.

6. A polymer emulsion having high solar reflectivity for application to pavement surfaces, comprising:
a) a mixture of polymer resin blended with a powder mixture of cement and sand and sodium carbonate, titanium dioxide and water wherein said polymer emulsion includes a quartz sand having non-skid properties so that when said polymer emulsion is mixed and cured and applied to a pavement surface at a thickness in the range of approximately 1/64 to 1/32 of an inch said polymer emulsion will have a minimum test value of slip resistance of 0.74 when dry according to test method ASTM D-2047.

7. A polymer emulsion for application to pavement surfaces as set forth in claim 6, wherein:
a) when cured, said polymer emulsion will have a minimum test value of slip resistance of 0.72 when wet according to test method ASTM D-2047.
